(19) United States
(12) Patent Application Publication
(10) Pub. No.: US 2025/0358134 A1
(43) Pub. Date: Nov. 20, 2025

(54) DISTRIBUTED LEDGER-BASED METHODS AND SYSTEMS FOR ESTABLISHING MUTUALLY AUTHENTICATED CONNECTION

(71) Applicant: TBCASOFT, INC., Sunnyvale, CA (US)

(72) Inventors: Chiahsin LI, San Jose, CA (US); Seeneng FOO, San Jose, CA (US)

(73) Assignee: TBCASOFT, INC., Sunnyvale, CA (US)

(21) Appl. No.: 19/281,734

(22) Filed: Jul. 27, 2025

Related U.S. Application Data
(62) Division of application No. 17/769,759, filed on Apr. 18, 2022.
(60) Provisional application No. 62/923,472, filed on Oct. 18, 2019.

(51) Int. Cl. H04L 9/32; H04L 9/00

(52) U.S. Cl. CPC H04L 9/3268; H04L 9/50

(57) ABSTRACT

Disclosed are methods and systems for publishing transactions for adding and removing roles and certificates to and from a distributed ledger and for authenticating certificates of two connected servers. The roles specify what server with the roles can publish what types of transactions for certificates and roles. When a role is requested, two transactions for adding the role and an issuer certificate are published to the distributed ledger. When a certificate of a server without any role is requested, only a transaction for adding the certificate is published to the distributed ledger. All the transactions are published through operation among a certificate-requesting server, a certificate-issuing server, and a distributed ledger network maintaining the distributed ledger. Two connected servers can verify authenticity of their counterpart's identities with the certificate retrieved from the distributed ledger and having the benefits of certificate immutability and availability of the distributed ledger technology.

The present invention is a divisional application claiming the benefit of U.S. patent application Ser. No. 17/769,759 filed on Apr. 18, 2022.

### BACKGROUND OF THE INVENTION

### 1. Field of the Invention

The present invention relates to methods and systems for establishing authenticated connection and, more particularly, to methods and systems adopting distributed ledger technology to establish authenticated connection.

### 2. Description of the Related Art

For assurance of secure network connection, mutual authentication is a security process in which entities authenticate each other before actual communication occurs. In a network environment, this requires that both the client and the server must provide digital certificates to prove their identities. For a mutual authentication process, a connection can occur only if the client and the server exchange, verify, and trust each other's certificates. The Transport Layer Security (TLS) protocol and its predecessor Secure Socket Layer (SSL) protocol have been developed to tackle such certificate exchange and verification. The SSL/TLS protocol adopts one of the most popular types of X.509 certificates which are public key certificates whose format is defined by the X.509 standard. The X.509 certificates securely associate cryptographic key pairs with identities such as websites, individuals, or organizations.

However, X.509 certificates are by no means flawless as far as the certificate immutability, certificate availability and certificate history are concerned. The impact against certificate immutability resides in hackers' attacks tampering the X.509 certificates. Once the root certificate or any of the certificate authorities (CA) are compromised, the system security will be compromised. Other drawback in certificate availability is that every server must maintain its own certificate database and inconsistency among certificate databases thus occurs. As to the downside of certificate history, all records including additions and revocations are absent in the databases of X.509 certificates for sake of the aforementioned two issues.

### SUMMARY OF THE INVENTION

An objective of the present invention is to provide methods and systems for publishing an issuer qualification and an issuer certificate, for publishing a server certificate to a distributed ledger and for certificate authentication, which add and remove certificates of servers in a distributed ledger maintained by a distributed ledger network to improve certificate immutability and certificate availability when it comes to verification of the certificates in the distributed ledger.

To achieve the foregoing objective, the method for publishing an issuer qualification and an issuer certificate through a certificate-issuing node (CI) and a certificate-requesting server (CR) in communication with each other to a distributed ledger maintained by a distributed ledger network including the CI and the method includes:
(a) the CI receiving qualification-related information from the CR;
(b) the CI signing and submitting an issuer qualification transaction to the distributed ledger;
(c) one of the CR and the CI creating and signing an issuer certificate for the CR and sending the issuer certificate to the CR when a signer of the issuer certificate is not the CR; and
(d) after the issuer qualification transaction is created in the distributed ledger, any one of the CR and the CI that has the issuer certificate signing an issuer certificate transaction and submitting the issuer certificate transaction to the distributed ledger.

To achieve the foregoing objective, the method for publishing a server certificate through a certificate-issuing server (CI) and a certificate-requesting server (CR) in communication with each other to a distributed ledger maintained by a distributed ledger network including the CI, and the method includes:
(a) a CI receiving certificate-related information from a CR;
(b) the CI creating and signing a server certificate for the CR and sending the server certificate to the CR; and
(c) the CI signing and submitting a server certificate transaction to the distributed ledger.

To achieve the foregoing objective, the method for authenticating certificates of a connecting server (CS) and a receiving server (RS) communicatively connected to each other and to a distributed ledger network maintaining a distributed ledger, and the method includes:
(a) the RS exchanging an identification with the CS;
(b) the RS retrieving a CS's certificate and a CS certificate issuer's public key from the distributed ledger based on a CS identification;
(c) the RS verifying if the CS's certificate is authentic with the CS certificate issuer's public key;
(d) after CS's certificate is verified to be authentic, the RS determining that the CS is authenticated to receive secret information from the RS.

To achieve the foregoing objective, the distributed ledger based system for publishing an issuer qualification and an issuer certificate includes a certificate-requesting server (CR) and a distributed ledger network.

The distributed ledger network maintains a distributed ledger, is communicatively connected to the CR, and includes a certificate-issuing node (CI). The CI receives qualification-related information from the CR, signs and submits an issuer qualification transaction to the distributed ledger. One of the CR and the CI further creates an issuer certificate for the CR and sends the issuer certificate to the CR when a signer of the issuer certificate is not the CR. After the issuer qualification transaction is created in the distributed ledger, one of the CR and the CI that has the issuer certificate signs an issuer certificate transaction and submits the issuer certificate transaction to the distributed ledger.

To achieve the foregoing objective, the distributed ledger based system for publishing a server certificate to a distributed ledger includes a certificate-requesting server (CR) and a distributed ledger network.

The distributed ledger network maintains the distributed ledger, is communicatively connected to the CR, and includes a certificate-issuing server (CI). The CI receives certificate-related information from the CR, creates and signs the server certificate for the CR, sends the server certificate to the CR, and signs and submits a server certificate transaction to the distributed ledger.

To achieve the foregoing objective, the distributed ledger based system for certificate authentication includes a distributed ledger network, a connecting server (CS) and a receiving server (RS).

The distributed ledger network maintains a distributed ledger.

The CS is communicatively connected to the distributed ledger network.

The RS is communicatively connected to the distributed ledger network, exchanges an identification with the CS, retrieves a CS's certificate and a CS certificate issuer's public key from the distributed ledger based on a CS identification to verify if the CS's certificate is authentic, and determines that the CS is authenticated to receive secret information from the RS when verifying that the CS's certificate is authentic.

According to the foregoing description, all servers with the roles or no role all have their own certificates, which are added or removed by authorized servers to and from the distributed ledger. The roles in the distributed ledger specify the authorities that regulate what servers with the roles are authorized to add what types of roles and certificates, thus preventing unauthorized entities from vandalizing the certificates and roles in the distributed ledger. A distributed ledger is, by its very nature, decentralized. This adds a layer of security because there is no centralized entity to target with malicious action. As the distributed ledger in a duplicated form can be spread out globally, the single point failure can be avoided. Thus, the roles and certificates published to the distributed ledger can also benefit from the immutability of the distribute ledger. As certificates and roles in the distributed ledger can be constantly and rapidly updated based on the consensus mechanism, inconsistency on certificates and roles in the distributed ledger appears to be out of the question. As a result, the certificates added to the distributed ledger by the methods and systems of the present invention can offer servers requiring to identify each other the reliance for certificate authentication, which is critical in secure communication between servers. Additionally, transparency can also viewed as a benefit of distributed ledger technology. A distributed ledger can allow all the information that is stored to be easily and freely accessible, which can add a huge amount of desired transparency to certificate authentication upon connection of servers.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram showing relationship between roles of servers and certificates created by the servers in accordance with the present invention;

FIG. 2 is a flow diagram showing a method of publishing an issuer qualification and an issuer certificate to a distributed ledger in accordance with the present invention;

FIG. 3 is a sequence diagram showing the method in FIG. 2 when a certificate-requesting server (CR) requests the role of trustee and a certificate-issuing server (CI) is of the role of trustee quorum;

FIG. 4 is a sequence diagram showing an embodiment of the method in FIG. 2 when the CR requests the role of operator and the CI is of the role of trustee;

FIG. 5 is a sequence diagram showing another embodiment of the method in FIG. 2 when the CR requests the role of operator and the CI is of the role of trustee;

FIG. 6 is a flow diagram showing steps for creating an issuer certificate of the method in FIG. 2;

FIG. 7 is a sequence diagram showing a method for publishing a server certificate to a distributed ledger in accordance with the present invention;

FIG. 8 is a sequence diagram showing an embodiment of a method for authenticating certificates of a connecting server (CS) and a receiving server in accordance with the present invention;

FIG. 9 is a sequence diagram showing another embodiment of the method in FIG. 8

FIG. 10 is a network architecture diagram showing an embodiment of a distributed ledger based system for publishing an issuer qualification and an issuer certificate in accordance with the present invention;

FIG. 11 is a network architecture diagram showing another embodiment of a distributed ledger based system for the system in FIG. 9 and a distributed ledger based system for publishing a serer certificate; and

FIG. 12 is a network architecture diagram showing a distributed ledger based network for certificate authentication.

### DETAILED DESCRIPTION OF THE INVENTION

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Each server in the present invention owns a certificate as an identity thereof stored in a distributed ledger maintained by a distributed ledger network. The certificate for a first server is submitted to a second server in connection therewith for verification the authenticity of the certificate. After the certificate is verified, the second server trusts the first server and is willing to send secret information to the first server. Likewise, such scenario can be applied the other way around when the second server provides its certificate to the first server for verification. For adding or removing the certificates to and from the distributed ledger, only servers with issuer's qualification are allowed to do so. To that end, issuer's qualifications should be also added to or removed from the distributed ledger to keep track what servers can add and remove what kinds of issuer's qualifications and certificates. There are distributed ledger rules that specify the types of issuer's qualifications of servers and the corresponding transactions of adding and removing or revoking issuer's qualifications and certificates of other servers.

Briefly speaking, the described embodiments concern one or more methods and systems for publishing issuer qualification and certificates in the distributed ledger and for certificate authentication. To ensure certificate authentication upon connection of any two servers, certificates retrieved from the distributed ledger based on identifications of the serves and exchanged certificates of the servers can be verified to see if the retrieved certificates are either available or if they match the exchanged certificates which can be taken as a basis of initiating authenticated information transfer between the servers. The distributed leger-based solution is adopted because of its foreseen improvement in certificate trust and immutability. The measure of the solution resides in a certificate store that stores multiple issuer's qualifications and certificates therein in the distributed ledger. As its name reflects, the issuer's qualifications are owned by servers with issuing authorities that can add or remove issuer's qualifications and certificates of other servers to and from the distributed ledger. Servers with the issuer's qualifications or issuer's roles can also have their certificates in the distributed ledger while servers having no issuer's qualifications can only own their certificates in the distributed ledger. To add a server with an issuer's role, a transaction of adding the certificate of the server and a transaction of adding the issuer's role of the server are published to the distributed ledger through interaction among the distributed ledger, and a certificate-requesting server (CR) and a certificate-issuing node (CI), which are two of multiple servers of the distributed ledger network. To add a server without any issuer's role, a transaction of adding the certificate of the server is published to the distributed ledger. Besides publishing transactions, the operation here also involves the use of a ledger key pair for signing and verifying the transaction and a certificate key pair for signing and verifying the certificate. When an issuer's role or a certificate is removed or revoked from the distributed ledger, a transaction of removing the issuer's role or revoking the certificate is published to the distributed ledger. More details concerning the methods and systems are elaborated in the following.

The goal of the present invention emphasizes that only issuers can sign and publish certificates. For fulfillment of the goal, two types of issuer's roles which are trustee and operator and three types of certificates which are root certificates, administrator certificates, and server certificates are addressed. Although all certificates have to be published to the distributed ledger, in a permissioned distributed ledger network, not every server but the servers with the issuer's roles can publish certificates and issuer's roles for other servers. The issuer's roles of trustee and operator stand for the root of trust and the administrator of each site that operates all servers at the site respectively and are authorized to publish certificates and issuer's roles. For conciseness, the term ‘role’ will replace ‘issuer's role’ hereinafter. Server having the role of trustee, the role of operator, and having no role owns a root certificate, an administrator certificate, and a server certificate respectively. Despite the name difference, the three types of certificates are basically the same as far as their common data fields are concerned except the ways of using their public key for verification. The root certificate and the administrator certificate pertain to issuer's certificates whose public keys can be used to verify the certificates signed by the issuers of the issuer's certificates while the public keys in server certificates cannot be used to verify other certificates simply because servers with the server certificates are not entitled to issue any certificate and there is no certificate signed by the servers with the server certificates.

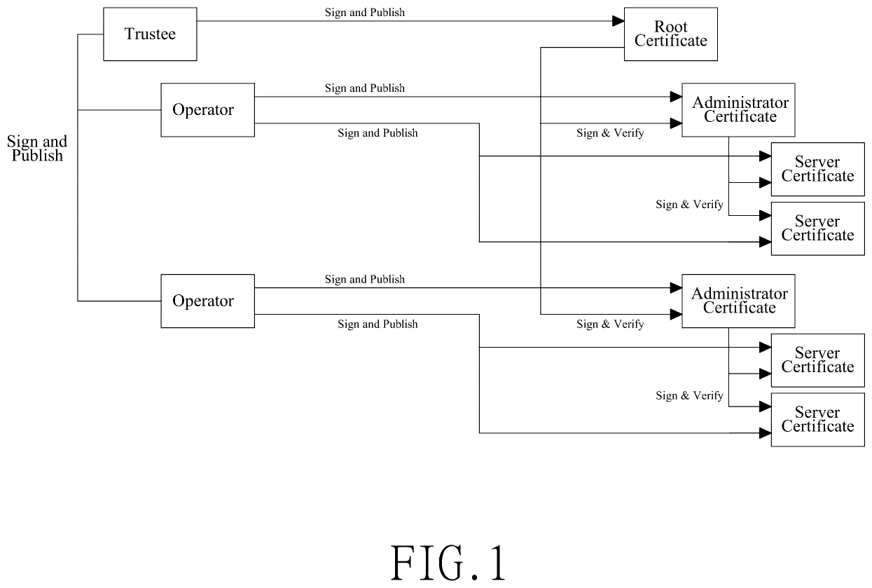

Considering the signing relationship between every certificate and its signer's certificate, a simplified way to rephrase the relationship is that an issuer's certificate signs and verifies a certificate signed by the issuer. Given any certificate for verification, the issuer's certificate signing the certificate can be recursively identified from the distributed ledger to verify the certificate and such verification process can trace all the way to the top certificate, which is the root certificate. With reference to FIG. 1 illustrating an example of the certificate types and the entities with the issuer's roles, the blocks on the left indicate servers with the issuer's roles in the distributed ledger network and the blocks on the right indicate the three types of certificates published by the authorized servers to the distributed ledger. As shown in FIG. 1, the servers having the role of operator are entitled to publish transactions of adding its administrator certificate and the server certificates of other servers without any issuer's role to the distributed ledger, the server having the role of trustee is entitled to publish a transaction of adding its root certificate to the distributed ledger. On the right side of FIG. 1, the three types of certificates in the distributed ledger are shown. Each administrator certificate can be used to verify the server certificates signed by the administrator certificate, and the root certificate can be used to verify the administrator certificates signed by the server publishing the root certificate. The verification process of the certificates may start from anywhere a server certificate or an administrator certificate is located and end at the root certificate with other intermediate administrator certificates between the server certificate or the administrator certificate and the root certificate, if available, sequentially verified. Meanwhile, the verification process does not have to go all the way up to the root certificate and can be ended when a condition is met or not. The condition includes but is not limited to if the certificate under verification is in a preapproved list or verification ends at the certificate it starts with. Nevertheless, the number of the servers having the roles of trustee and operator, the numbers of the root certificate, the administrator certificate, and the server certificate, and the hierarchical structure of the certificates are not limited to those shown in FIG. 1.

The following table that shows the distribute ledger rules about what roles can publish what types of transactions to the distributed ledger digs deeper into the relationship between the roles and the certificates.

Table of distributed ledger rules

| | | | Trust |
|---|---|---|---|
| Transaction types\Roles | Trustee | Operator | Quorum |
| Add/Remove Trustee | No | No | Yes |
| Add/Remove Operator | Yes | Yes | No |
| Add/Revoke Root Certificate | Yes | No | No |
| Add/Revoke Administrator Certificate | Yes | Yes | No |
| Add/Revoke Server Certificate | No | Yes | No |

According to the table, a server with the role of trustee is entitled to publish transactions of adding and removing the role of operator, a root certificate, and an administrator certificate associated with other servers to the distributed ledger. It is noted that the server having the role of trustee is not entitled to add or revoke a server certificate of another server. A server having the role of trustee is not entitled to publish the transactions of adding and removing the role of trustee of other servers alone unless the server is the only one with the role of trustee in the distributed ledger. Instead, servers with the role of trustee quorum, which is defined to be a congregate role for a super majority of at least one server in the distributed ledger with the role of trustee, is entitled to publish transactions of adding and removing servers with the role of trustee. In contrast to the role of trustee, a server having the role of operator is entitled to publish transactions of adding and removing or revoking the role of operator, an administrator certificate and a server certificate of other servers to the distributed ledger. It is noted that servers with the role of trustee and servers with the role of operator can both publish transactions of adding, removing and revoking the role of operator and administrator certificates of servers. As for the server having no role at all, it is not entitled to publish any transaction.

As the certificate store in the distributed ledger that contains the issuer's roles and the certificates is rudimentary to certificate authentication of two servers in connection with each other, how to publish transactions for adding and removing the roles and the certificates are introduced first. When the certificate store is initially built up, it starts with a genesis transaction published thereto to create a very first server with a role of trustee. The genesis transaction includes a decentralized identifier (DID) of the trustee, a public key for verifying a distributed ledger signature of any transaction published by the trustee, and a role of trustee.

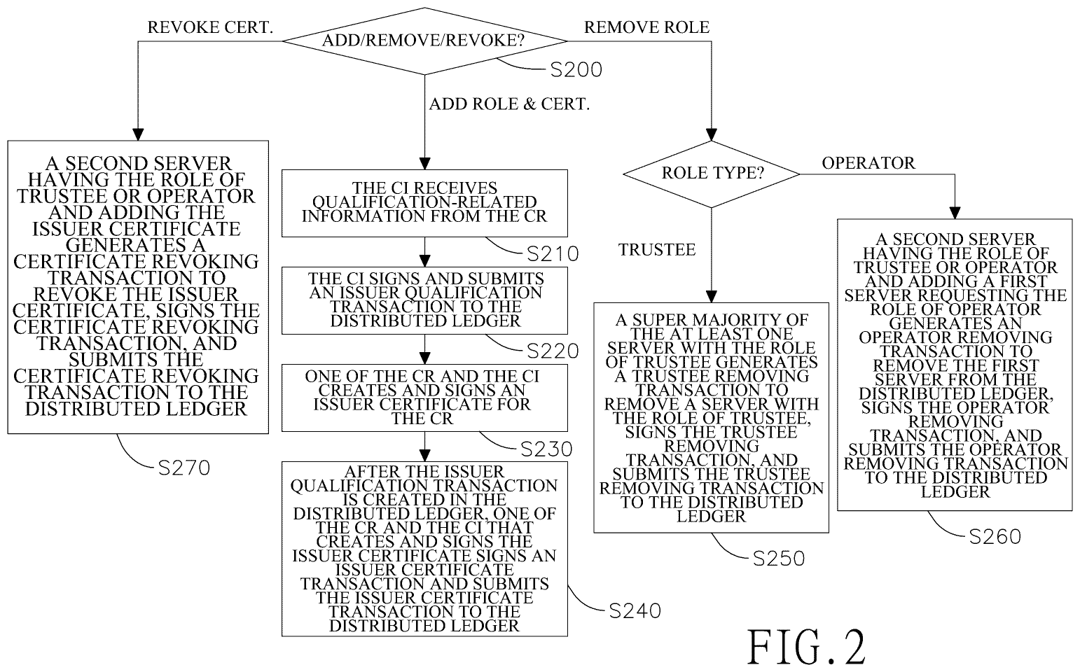

With reference to FIG. 2, an embodiment of a method for publishing an issuer qualification and an issuer certificate to a distributed ledger in accordance with the present invention is provided. The method in the present embodiment involves a certificate-requesting server (CR) and a certificate-issuing node (CI) both of which are a part of the distributed ledger network. The CI may include one or more than one server. The method is applied when the CI is a node having a role of trustee quorum or trustee in the distributed ledger and the CR requests to be added by the CI to the distributed ledger with a role of trustee or operator. In this method, the server with no role and a server certificate is ruled out from the discussion of the method. As transactions published to the distributed may intend to add or remove roles and certificates, the method includes the following steps from the step S210 to S240 for adding roles and certificates.

Step S200: The CI determines a type of transaction to be published. The types of transactions include to add role and certificate, remove role, and revoke certificate.

Step S210: When determining the transaction type of adding role and certificate, the CI receives qualification-related information from the CR. The qualification related information is required for adding the CR's issuer qualification or role in a transaction that is subsequently added to the distributed ledger and includes a DID, a ledger public key, and a role of the CR. Basically, each server with a role in the certificate store has a ledger key pair and a certificate key pair both of which pertain to asymmetric key pairs. The ledger pair has a ledger public key and a ledger private key and the certificate pair has a certificate public key and a certificate private key. The ledger private key associated with the server is stored at the server and is used by the server to sign any transaction to be published to the certificate store. The ledger public key associated with the server will be sent to a transaction for adding the server, such as the transaction mentioned in the current step for adding the CR, to the distributed ledger. Thus, the distributed ledger can verify any later transaction signed by the server with the ledger public key of the server. On the other hand, the certificate private key of a server is used by the server to sign a certificate of another server which may be one of an administrator certificate and a server certificate. The certificate public key of the server is included in the certificate of the server for verifying the certificates of other servers signed by the server.

Step S220: The CI signs and submits an issuer qualification transaction to the distributed ledger. The issuer qualification transaction serves to onboard the CR to the distributed ledger, includes a DID and a ledger public key of the CR, a CI's DID, and a CR's role to be added to the distributed ledger, and is signed by a ledger private key of the CI. From the foregoing table of distributed ledger rules, the CR may request to be added with the role of trustee or operator while the CI may be of the role of trustee quorum or trustee. When the CR requests the role of trustee, the CI should be of the role of trustee quorum and includes at least one server. When the CR requests the role of operator, the CI may be of the role of trustee or operator and is an individual server.

Step S230: One of the CR and the CI creates and signs an issuer certificate for the CR and sends the issuer certificate to the CR when a signer of the issuer certificate is not the CR. When the CR requests a role of trustee, it is the CR that creates and signs the issuer certificate and the issuer certificate is a root certificate. When the CR requests a role of operator, it is the CI that creates and signs the issuer certificate and the issuer certificate is an administrator certificate. Depending on the role requested by the CR, the issuer certificate is signed by the certificate private key of one of the CR and the CI that creates the issuer certificate. In the event that the creator of the issuer certificate is CI, CI must send the issuer certificate to the CR for its storage and later verification.

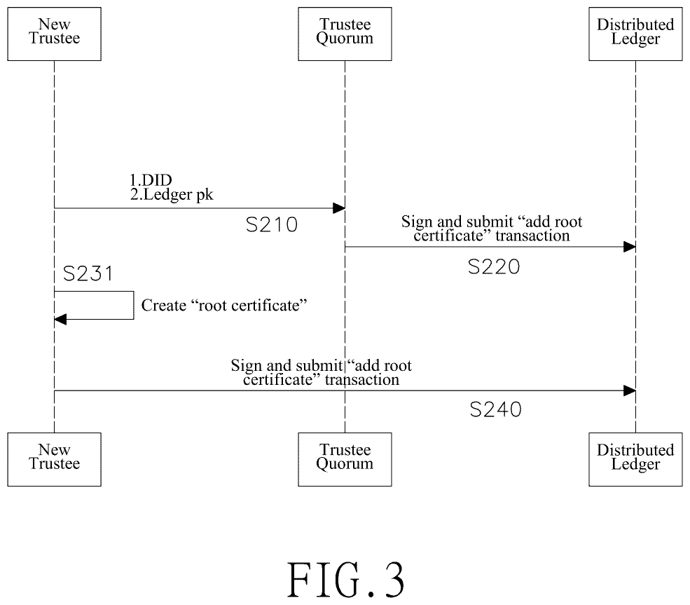

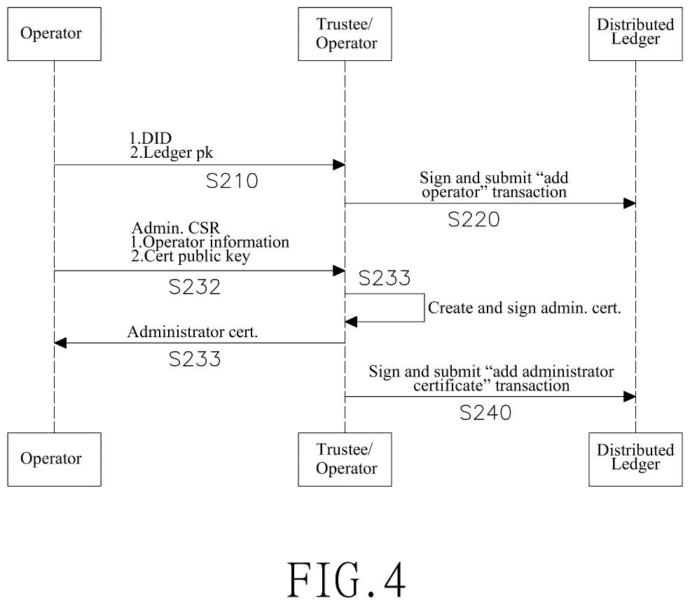

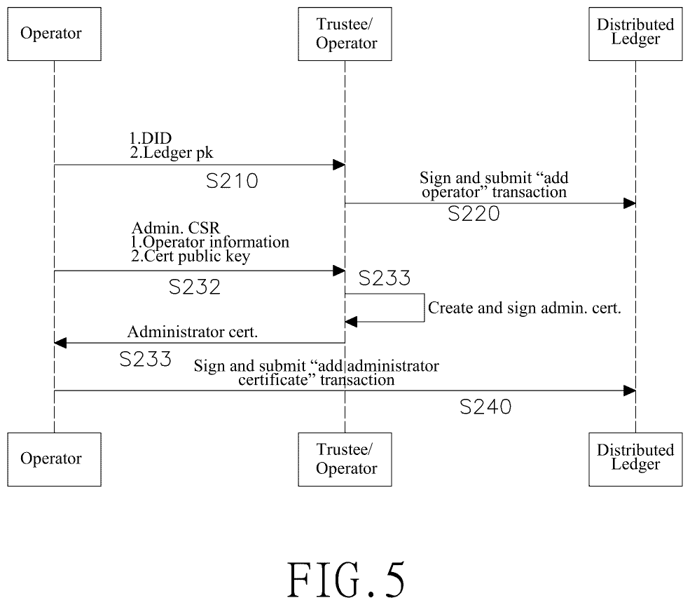

Step S240: after the issuer qualification transaction is created in the distributed ledger, any one of the CR and the CI that has the issuer certificate signs an issuer certificate transaction and submits the issuer certificate transaction to the distributed ledger. It is stressed that the issuer qualification transaction should be signed and submitted to the distributed ledger only after the issuer qualification transaction is created in the distributed ledger. When the CR requests the role of trustee, the CR creates its own root certificate and is the only one that has the root certificate, such that it is the CR that signs and submits the issuer certificate transaction to the distributed ledger as shown in FIG. 3. When the CR requests the role of operator, as the CI creates and signs the administrator certificate for the CR and further sends the administrator certificate to the CR, both the CI and CR have the administrator certificate and either one of the CI and CR can therefore sign and submit the issuer certificate transaction to the distributed ledger as shown in FIGS. 4 and 5. As for the issuer certificate transaction, it includes a submitter's DID, a certificate ID, an issuer certificate, and a signature of the submitter. The submitter may be any one of CR and CI that has the issuer certificate. The certificate ID is a hash value of the issuer certificate. The issuer certificate includes an identification and a certificate public key of the CR, an optional role of the CR, and a signature signed by a certificate private key of the certificate signer of the issuer certificate. The CR's identification is a subject alternative name (SAN), which may be a web address, for example, www.tbcasoft.com. The role of the CR is optional as it may be provided for applications requiring to verify and utilize the role of the issuer certificate associated with a server owing the issuer certificate. Before publishing the issuer certificate transaction, the submitter of the issuer certificate transaction signs the issuer certificate transaction with its ledger private key.

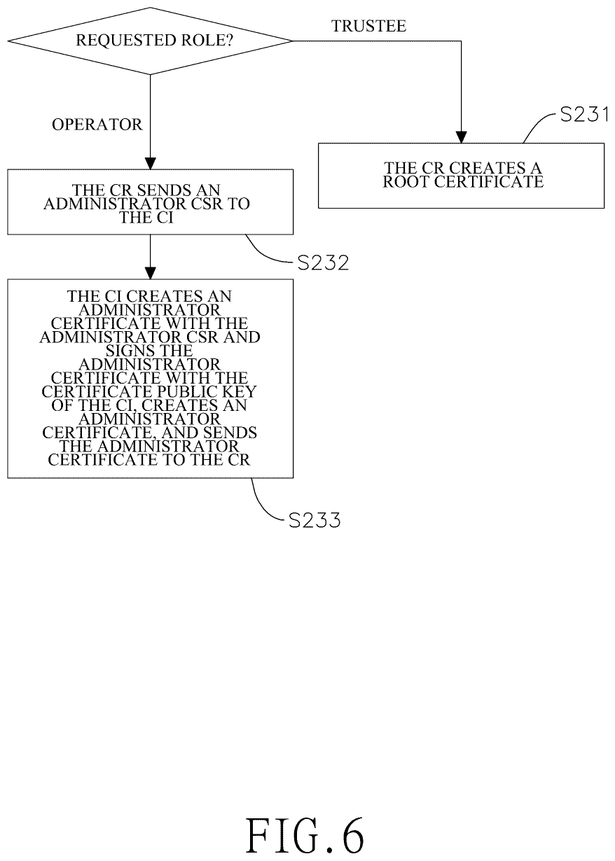

Depending on the role of the certificate-requesting server, the step S230 may include different steps varying with the role of the CR. When the role of the CR is trustee, FIG. 3 shows a sequence diagram for the CR requesting the role of trustee and FIGS. 4 and 5 shows a sequence diagram for the CR requesting the role of operator. With reference to FIG. 6, to adapt to the requesting role of the CR, the step S230 includes the following steps.

Step S231: When the role requested by the CR is trustee, the CR creates a root certificate. It is the CR that creates the root certificate due to the distributed ledger rules specifying that only the server with a role of trustee can add a root certificate.

When the role of the CR is operator, the step S230 includes the following steps.

Step S232: When the role requested by the CR is operator, the CR sends an administrator certificate signing request (CSR) to the CI. The administrator CSR includes operator information and the certificate public key of the CR. The operator information includes fields of SAN, business name, department name, city, state, country, and contact email of the CR.

Step S233: The CI creates an administrator certificate with the administrator CSR and signs the administrator certificate with the certificate public key of the CI, creates an administrator certificate, and sends the administrator certificate to the CR. It is the CI that creates the root certificate due to the distributed ledger rules specifying that the server with a role of trustee can add an administrator certificate.

What the difference between FIGS. 4 and 5 is the server that publishes the issuer certificate transaction. As long as the server has the role for publishing the issuer certificated transaction, it should not matter if the CR or CI publishes the issuer certificate transaction. As the role to be published is operator, either one of the CI having the role of trustee in FIG. 4 and the CR having the role of operator in FIG. 5 can publish the issuer certificate transaction.

When intending to remove any server or revoke any certificate in the certificate store, a transaction for removing the server or revoking the certificate can be published to the distributed ledger. Accordingly, the foregoing method further includes the following steps for removing servers with roles and revoking certificates in the distributed ledger. With reference to FIG. 2, the foregoing method further includes the following steps for removing and revoking roles and certificates.

Step S250: When determining a type of removing role and removing a server with the role of trustee, a super majority of the at least one server with the role of trustee generates a trustee removing transaction to remove the server, signs the trustee removing transaction, and submits the trustee removing transaction to the distributed ledger. The current step involves operation for removing a server with the role of trustee. The trustee removing transaction includes a DID of the server and at least one DID corresponding to the super majority of the at least one server and is signed by at least one ledger private key of the super majority of the at least one server;

Step S260: When determining a type of removing role and removing a first server with the role of operator, a second server having the role of trustee or operator and adding the first server to the distributed ledger generates an operator removing transaction to remove the first server from the distributed ledger, signs the operator removing transaction, and submits the operator removing transaction to the distributed ledger. The current step involves operation for removing a server with the role of operator. The operator removing transaction includes a DID of the second server and a DID of the first server and is signed by a ledger private key of the second server.

Step S270: When determining a type of revoking certificate and revoking the issuer certificate of a first server having the role of operator in the distributed ledger, a second server having the role of trustee and adding the issuer certificate generates a certificate revoking transaction to revoke the issuer certificate in the distributed ledger, signs the certificate revoking transaction, and submits the certificate revoking transaction to the distributed ledger. The current step involves operation for removing an issuer certificate, possibly a root certificate or an administrator certificate, associated with a server with the role of trustee or operator. The certificate revoking transaction includes the certificate ID of the issuer certificate and a DID of the second server, and is signed by a ledger private key of the second server.

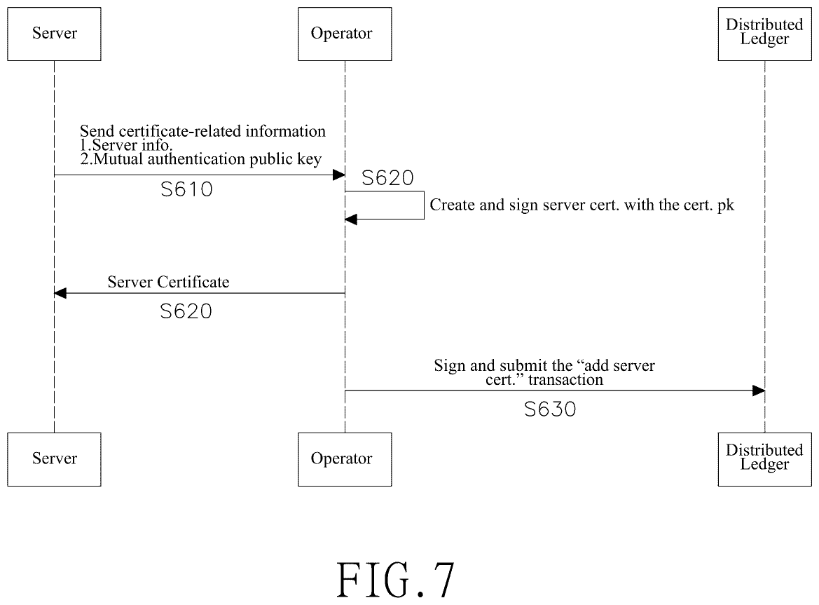

Because there is only one transaction for adding a server certificate to the distributed ledger, the method for publishing a server certificate to the distributed ledger differs from the foregoing method for publishing issuer qualifications and certificates in the absence of the issuer qualification transaction. FIG. 7, which is a sequence diagram, shows a method for publishing a server certificate to the distributed ledger in accordance with the present invention includes the following steps. The distributed ledger is maintained by a distributed ledger network. The distributed ledger network includes multiple servers two of which are a certificate-issuing node (CI) and a certificate-requesting server (CR).

Step S610: The CI receives certificate-related information from a CR. As a server certificate needs to be created only, the certificate-related information is all the CI requires from the CR. The certificate-related information includes server information and an authentication public key. The server information includes an internet protocol (IP) address and a hostname of the CR.

Step S620: The CI creates and signs a server certificate for the CR and sends the server certificate to the CR. The server certificate includes a SAN of the CR and the authentication public key, and is signed by a certificate private key of the CI.

Step S630: The CI signing and submits a server certificate transaction to the distributed ledger. The server certificate transaction includes a certificate ID of the server certificate, the server certificate, and a DID of the CI and is signed by a ledger private key of the CI. The certificate IS is a hash value of the server certificate.

To revoke a server certificate added to the distributed ledger, the method for publishing a server certificate to the distributed ledger further includes the following step.

A server having the role of operator and adding the server certificate generates a certificate revoking transaction to revoke the server certificate in the distributed ledger, signs the certificate revoking transaction, and submits the certificate revoking transaction to the distributed ledger. The certificate revoking transaction includes the certificate ID of the server certificate and a DID of the server that adds the server certificate, and is signed by a ledger private key of the server adding the issuer certificate.

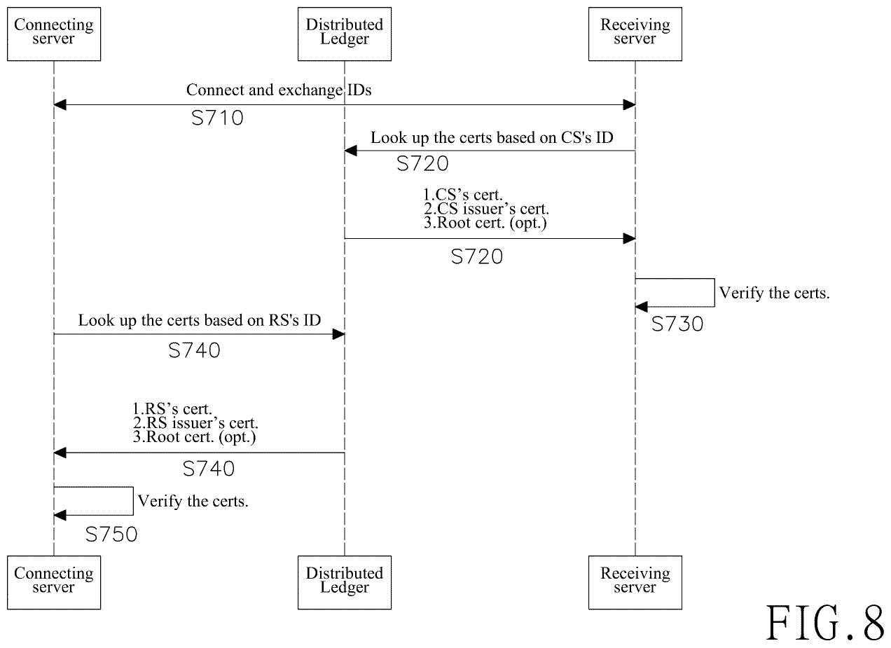

After how to add and remove roles and certificates to the distributed ledger is implemented, the next subject of interest would be how to use the certificates for servers in connection with each other to verify the authenticity of their server certificates to establish mutually authenticated information exchange. With reference to FIG. 8, a method for authenticating certificates of a connecting server (CS) and a receiving server (RS) in a distributed ledger network maintaining a distributed ledger in accordance with the present invention includes the following steps over the side of the RS.

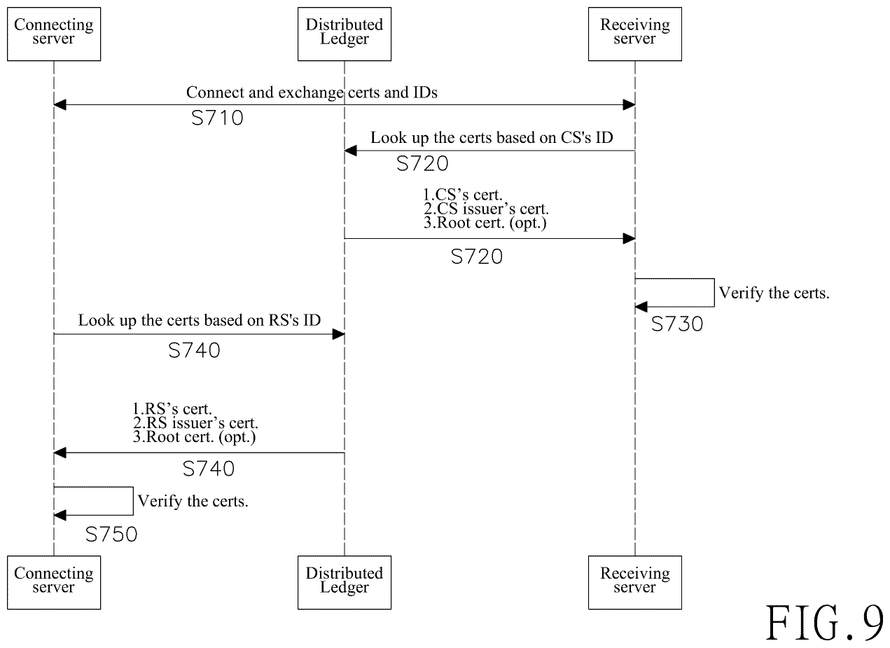

Step S710: The RS and the CS exchange their identifications. The RS's identification is a SAN of the RS and the CS's identification is a SAN of the CS. The RS and the CS exchanges their SANs with each other. In addition to the identification, in one embodiment, the RS and the CS can further exchange their certificates as shown in FIG. 9.

Step S720: The RS retrieves a CS's certificate and a CS certificate issuer's public key from the distributed ledger based on a CS identification. The CS identification can be used to retrieve the CS's certificate and a CS certificate issuer's certificate which has a CS certificate issuer's public key from the distributed ledger. The CS certificate issuer's public key serves to verify the CS's certificate signed by the CS certificate issuer having the CS certificate issuer's certificate. If no certificate can be retrieved from the distributed ledger with the RS's identification, it can signal that the RS's certificate is not authentic in a fast and simple way.

Step S730: The RS verifies if the CS's certificate is authentic with the CS certificate issuer's public key. Once the CS's certificate and the CS certificate issuer's public key are accessible to the RS, they can be used to verify the CS's certificate is authentic directly. There are other verification approaches available for choices. In one verification approach using the exchanged certificates, the RS further verifies if both the exchanged CS's certificate and the retrieved CS's certificate are matched with the CS certificate issuer's public key. In another verification approach, the RS initializes the CS's certificate as a current certificate, and loops to retrieve a next certificate that signs the current certificate with a private key of an certificate issuer of the next certificate, to verify the current certificate with the public key in the next certificate, to determine that the CS's certificate is verified to be authentic when the current certificate is verified or a verification condition is met, and otherwise, to updates the current certificate to the next certificate. For example, the verification condition may be if the certificate to be verified is in a preapproved list.

After the CS's certificate is verified to be authentic, it means that one-sided certificate authentication on the RS's side is successfully verified and the CS is a trustful server to exchange information with and the RS is willing to send and receive secret information to and from the CS.

The method further includes similar steps for authentication of the RS's certificates as follows.

Step S740: The CS retrieves an RS's certificate and an RS certificate issuer's public key from the distributed ledger based on an RS identification.

Step S750: The CS verifies if the RS's certificate is authentic with the RS certificate issuer's public key.

Likewise, after the RS's certificate is verified to be authentic, it means that one-sided certificate authentication on the CS's side is successfully verified and the RS is a trustful server to exchange information with and the CS is willing to send and receive secret information to and from the RS.

Owing to duplication between the authentication of certificates of the RS and CS, detailed description for the steps S740 and S750 are not repeated.

After the foregoing methods are elaborated, the systems for performing the foregoing methods are the next subject for discussion. As there are three methods for publishing issuer qualifications and issuer certificates to a distributed ledger, publishing server certificates to a distributed ledger, and authenticating certificates of two servers in a distributed ledger network, three systems can correspond to the respective methods, namely, a distributed ledger based system for publishing issuer qualifications and issuer certificates to a distributed ledger, a distributed ledger based system for publishing server certificates to a distributed ledger, and a distributed ledger based system for certificate authentication.

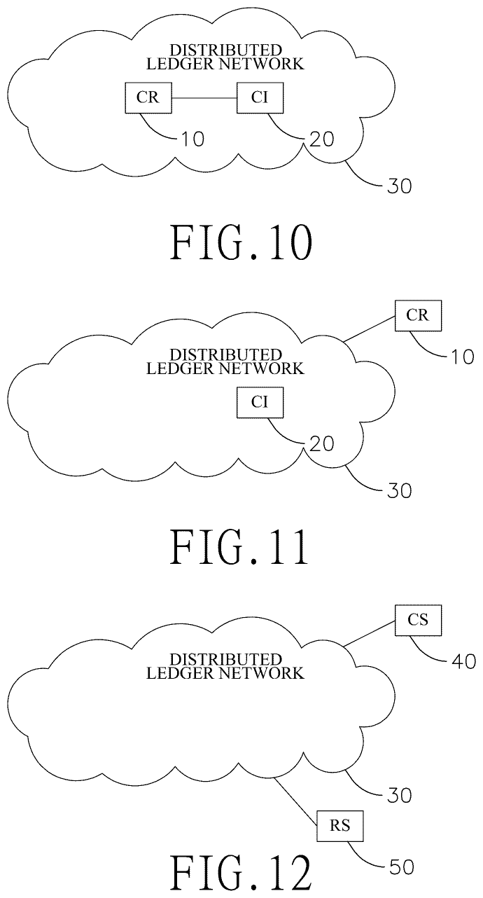

What are involved in the distributed ledger based system for publishing issuer qualifications and issuer certificates are the CR, CI and a distributed ledger network. The CR and the CI are a server and a node respectively. Being a node, the CI may include at least one server when having the role of trustee quorum and may be nothing but one server when having the role of trustee or operator. The CR and CI may be a part of the distributed ledger network or not depending on if both need to publish transactions to the distributed ledger. When the CR 10 requests a role of trustee and the CI 20 s of a role of trustee quorum, the CR 10 and the CI 20 must all stay in the distributed ledger network 30 as shown in FIG. 10 because both the CR 10 and CI 20 publishes transactions for adding a root certificate and the CR 10 with the role of trustee to the distributed ledger. When the CR 10 requests a role of operator and the CI 20 is of a role of trustee, the CI 20 must always stay in the distributed ledger network 30 while the CR 10 may or may not stay the in the distributed ledger network 30 because the issuer certificate transaction may be published by the CR 10 or the CI 20. When the issuer certificate transaction is published by the CR 10, the CR 10 must also stay in the distributed ledger network 30 as shown in FIG. 10. When the issuer certificate transaction is published by the CI, the CR may stay out of the distributed ledger network 30 as shown in FIG. 11 but needs to connect thereto. The distributed ledger based system for publishing server certificates as shown in FIG. 11 also includes the CR 10 and the CI 20 each of which is a server. Being the only one having the role capable of publishing the server certificate to the distributed ledger, the CI 20 of the system should stay in the distributed ledger network 30. Unlike the CI 20, the CR 10 has no such necessity of staying in the distributed ledger network 30 for sake of no role of publishing any transaction. However, the CR 10 should be connected to the distributed ledger network. As for the distributed ledger based system for certificate authentication which is shown in FIG. 12, the connecting server (CS) 40 and the receiving server (RS) 50 involved in the system need not to stay in the distributed ledger network 30 because certificate authentication is the subject without concern for publishing any transaction but are supposed to be in connection with each other.

The methods and systems in the present invention are advantageous in providing the certificate immutability arising from the fact that distributed ledger is immutable and shared without being subject to the control of a single centralized authority, making the distribute ledger solution fit very well for the certificate authentication. As for certificate availability, the servers in the distribute ledger network won't need to manage the distributed ledgers in the distributed ledger network since the distributed ledgers in the distributed ledger network will be constantly maintained by the consensus mechanism for assurance of consistency throughout all the distributed ledgers in the distributed ledger network.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for publishing and authenticating certificates, when an issuer qualification is published through a certificate-issuing node (CI) and an issuer certificate is published through one of the CI and a certificate-requesting server (CR) in communication with the CI to a distributed ledger maintained by a distributed ledger network, the method comprising:
(a) the CI receiving qualification-related information from the CR;
(b) the CI signing and submitting an issuer qualification transaction to the distributed ledger, wherein the issuer qualification transaction includes the qualification-related information;
(c) one of the CR and the CI creating and signing an issuer certificate for the CR and when a signer of the issuer certificate is not the CR, sending the issuer certificate to the CR; and
(d) after the issuer qualification transaction is created in the distributed ledger, any one of the CR and the CI that has the issuer certificate signing an issuer certificate transaction and submitting the issuer certificate transaction to the distributed ledger;
wherein the issuer certificate transaction includes the issuer certificate, and the issuer qualification transaction includes the qualification-related information.

2. The method of claim 1, wherein the qualification related information includes a decentralized identifier (DID), a ledger public key and a role of the CR.

3. The method of claim 1, wherein the issuer qualification transaction includes a DID and a ledger public key of the CR, a CI's DID, and a CR's role to be added to the distributed ledger.

4. The method of claim 1, wherein the CI signs the issuer qualification transaction with a CI's ledger private key.

5. The method of claim 3, wherein the issuer certificate transaction includes a submitter's DID, a certificate ID, the issuer certificate, and a signature of the submitter, wherein the certificate ID is a hash value of the issuer certificate, the issuer certificate includes an identification and a certificate public key of the CR, an optional role of the CR, and a signature signed by a certificate private key of the certificate signer of the issuer certificate.

6. The method of claim 5, wherein the CR's identification is a subject alternative name.

7. The method of claim 1, wherein an issuer certificate transaction submitter signs the issuer certificate transaction with its ledger private key, when the issuer certificate transaction is submitted by the CR, the distributed ledger network includes the CR, and when the issuer certificate transaction is submitted by the CI, the distributed ledger network does not include the CR.

8. The method of claim 3, wherein the CR's role to be added to the distributed ledger is trustee and the CI's role in the distributed ledger is trustee quorum, the trustee quorum is defined to be an issuing role for a super majority of at least one server in the distributed ledger having the role of trustee, and the CI includes the super majority of the at least one server.

9. The method of claim 8, wherein the CR's role to be added to the distributed ledger is operator and the CI's role in the distributed ledger is trustee or operator.

10. The method of claim 8, wherein at the step (c), the CR creating the issuer certificate and signing the issuer certificate with a certificate private key of the CR paired to the certificate public key of the CR.

11. The method of claim 9, wherein at the step (c), the CI receiving an issuer certificate signing request (CSR) from the CR, and creating the issuer certificate with the issuer CSR, and signing the issuer certificate with a certificate private key of the CI paired to the certificate public key of the CI, wherein the issuer CSR includes operator information and the CR's certificate public key.

12. The method of claim 11, wherein the operator information includes fields of subject alternative name, business name, department name, city, state, country, and contact email of the CR.

13. The method of claim 1, when certificates of a connecting server (CS) and a receiving server (RS) communicatively connected to each other and to a distributed ledger network maintaining a distributed ledger are authenticated, the method comprising:
(e) the RS exchanging an identification with the CS;
(f) the RS retrieving a CS's certificate and a CS certificate issuer's public key from the distributed ledger based on a CS identification, wherein the CS certificate issuer's public key is included in the issuer certificate published to the distributed ledger in the step (d) by the CS certificate issuer which acts as one of the CI and the CR with the qualification-related information;
(g) the RS verifying if the CS's certificate is authentic with the CS certificate issuer's public key;
(h) after CS's certificate is verified to be authentic, the RS determining that the CS is authenticated to receive secret information from the RS.

14. The method of claim 13, wherein
(1) the CS retrieves an RS's certificate and an RS certificate issuer's public key from the distributed ledger based on an RS identification;
(2) the CS verifies if the RS's certificate is authentic with the RS certificate issuer's public key; and
(3) after the RS's certificate is verified, the CS determining that the RS is authenticated to receive secret information from the CS.

15. The method of claim 14, wherein at step (e) the RS further exchange a certificate with the CS.

16. The method of claim 15, wherein at the steps (g) and (2), the RS further verifies if both the exchanged CS's certificate and the retrieved CS's certificate are matched with the CS certificate issuer's public key, and the CS further verifies if both the exchanged RS's certificate and the retrieved RS's certificate are matched with the RS certificate issuer's public key.

17. The method of claim 13, wherein the CS identification is a subject alternative name of the CS and the RS identification is a subject alternative name of the RS.

18. The method of claim 13, wherein
at step (g), the RS initializes the CS's certificate as a current certificate, and loops to retrieve a next certificate that signs the current certificate with a private key of an certificate issuer of the next certificate, to verify the current certificate with the public key in the next certificate, to determine that the CS's certificate is verified to be authentic when the current certificate is verified or a verification condition is met, and otherwise, to updates the current certificate to the next certificate; and
at step (2), the CS initializes the RS's certificate as a current certificate, and loops to retrieve a next certificate that signs the current certificate with a private key of an certificate issuer of the next certificate, to verify the current certificate with the public key in the next certificate, to determine that the RS's certificate is verified to be authentic when the current certificate is verified or the verification condition is met, and otherwise, to updates the current certificate to the next certificate.

19. A distributed ledger based system for publishing and authenticating certificates, comprising:
a certificate-requesting server (CR); and
a distributed ledger network maintaining a distributed ledger, communicatively connected to the CR, and including a certificate-issuing node (CI);
wherein
the CI receives qualification-related information from the CR, signs and submits an issuer qualification transaction to the distributed ledger, wherein the issuer qualification transaction includes the qualification-related information;
one of the CR and the CI further creates an issuer certificate for the CR and when a signer of the issuer certificate is not the CR, sends the issuer certificate to the CR;
after the issuer qualification transaction is created in the distributed ledger, one of the CR and the CI that has the issuer certificate signs an issuer certificate transaction and submits the issuer certificate transaction to the distributed ledger;
wherein the issuer certificate transaction includes the issuer certificate and the issuer qualification transaction includes the qualification-related information.

20. The system of claim 19, wherein the qualification related information includes a decentralized identifier (DID), a ledger public key and a role of the CR.

21. The system of claim 19, wherein the issuer qualification transaction includes a DID and a ledger public key of the CR, a CI's DID, and a CR's role to be added to the distributed ledger.

22. The system of claim 19, wherein the CI signs the issuer qualification transaction with a CI's ledger private key.

23. The system of claim 22, wherein the issuer certificate transaction includes a submitter's DID, a certificate ID, the issuer certificate, and a signature of the submitter, wherein the certificate ID is a hash value of the issuer certificate, the issuer certificate includes an identification and a certificate public key of the CR, an optional role of the CR, and a signature signed by a certificate private key of the certificate signer of the issuer certificate.

24. The system of claim 19, wherein an issuer certificate transaction submitter signs the issuer certificate transaction with its ledger private key, when the issuer certificate transaction is submitted by the CR, the distributed ledger network includes the CR, and when the issuer certificate transaction is submitted by the CI, the distributed ledger network does not include the CR.

25. The system of claim 19 for certificate authentication, comprising:
a connecting server (CS) communicatively connected to the distributed ledger network; and
a receiving server (RS) communicatively connected to the distributed ledger network, exchanging an identification with the CS, retrieving a CS's certificate and a CS certificate issuer's public key from the distributed ledger based on a CS identification to verify if the CS's certificate is authentic, and determining that the CS is authenticated to receive secret information from the RS when verifying that the CS's certificate is authentic, wherein the CS certificate issuer's public key is included in the issuer certificate published to the distributed ledger by the CS certificate issuer which acts as one of the CI and the CR with the qualification-related information.

26. The system of claim 25, wherein the CS retrieves an RS's certificate and an RS certificate issuer's public key from the distributed ledger based on an RS identification to verify if the RS's certificate is authentic, and determines that the RS is authenticated to receive secret information from the CS when verifying that the RS's certificate is authentic.

27. The system of claim 26, wherein the RS further exchanges a certificate with the CS.

28. The system of claim 27, wherein the RS verifies if both the exchanged CS's certificate and the retrieved CS's certificate are matched with the CS certificate issuer's public key, and the CS verifies if both the exchanged RS's certificate and the retrieved RS's certificate are matched with the RS certificate issuer's public key.
